(19) United States
(12) Patent Application Publication
(10) Pub. No.: US 2018/0310241 A1
(43) Pub. Date: Oct. 25, 2018

(54) PROVIDING SERVICE

(71) Applicant: NOKIA SOLUTIONS AND NETWORKS OY, Espoo (FI)

(72) Inventors: Ling YU, Kauniainen (FI); Vinh VAN PHAN, Oulu (FI); Kari Veikko HORNEMAN, Oulu (FI)

(21) Appl. No.: 15/569,364

(22) PCT Filed: Apr. 27, 2015
(86) PCT No.: PCT/EP2015/059053

§ 371 Date: Oct. 25, 2017

(51) Int. Cl. H04W 48/20; H04W 4/46; H04W 76/14; H04W 76/27; H04W 24/02

(52) U.S. Cl. CPC H04W 48/20; H04W 4/46; H04W 84/18; H04W 76/27; H04W 24/02; H04W 76/14

(57) ABSTRACT

An aspect is an apparatus comprising: at least one processor; and at least one memory including computer program code, the at least one memory and the computer program code configured to, with the at least one processor, cause the apparatus at least to: detect absence of a cell providing a given service; on the basis of the detection, carry out configuration to operate as an ad-hoc cell providing the given service, and in connection with the configuration, cause establishment of a backhaul connection for the given service.

### TECHNICAL FIELD

The invention relates to communications.

### BACKGROUND

Modern communication networks and wireless communication networks in particular are under constant development. New uses and applications for wireless communication are planned. One item under study is vehicular communication systems where vehicles and mobile terminals in the vehicles are communicating with a network, possibly utilising communication nodes placed on the road side.

### BRIEF DESCRIPTION

According to an aspect, there is provided an apparatus comprising: at least one processor; and at least one memory including computer program code, the at least one memory and the computer program code configured to, with the at least one processor, cause the apparatus at least to: detect absence of a cell providing a given service; on the basis of the detection, carry out configuration to operate as an ad-hoc cell providing the given service, and in connection with the configuration, cause establishment of a backhaul connection for the given service.

According to another aspect, there is provided an apparatus comprising: at least one processor; and at least one memory including computer program code, the at least one memory and the computer program code configured to, with the at least one processor, cause the apparatus at least to: receive, by a service unit, a backhaul connection request from an ad-hoc cell node, while in a disconnected state regarding a service provided by the ad-hoc cell node; as a response to the request, access the ad-hoc cell as user equipment to provide an access connection, and provide a backhaul connection for the ad-hoc cell node by using the access connection and a backhaul connection established for operating as the service unit.

According to another aspect, there is provided a method, comprising: detecting absence of a cell providing a given service; on the basis of the detection, carrying out configuration to operate as an ad-hoc cell providing the given service, and in connection with the configuration, causing establishment of a backhaul connection for the given service.

According to another aspect, there is provided a method comprising: receiving, by a service unit, a backhaul connection request from an ad-hoc cell node, while in a disconnected state regarding a service provided by the ad-hoc cell node; as a response to the request, accessing the ad-hoc cell as user equipment to provide an access connection, and providing a backhaul connection for the ad-hoc cell node by using a backhaul connection established for operating as the service unit.

According to another aspect, there is provided a computer program embodied on a non-transitory computer-readable medium, the computer program comprising program code portions for controlling executing of a process, the process comprising: detecting absence of a cell providing a given service; on the basis of the detection, carrying out configuration to operate as an ad-hoc cell providing the given service, and in connection with the configuration, causing establishment of a backhaul connection for the given service.

According to another aspect, there is provided a computer program embodied on a non-transitory computer-readable medium, the computer program comprising program code portions for controlling executing of a process, the process comprising: receiving, by a service unit, a backhaul connection request from an ad-hoc cell node, while in a disconnected state regarding a service provided by the ad-hoc cell node; as a response to the request, accessing the ad-hoc cell as user equipment to provide an access connection, and providing a backhaul connection for the ad-hoc cell node by using a backhaul connection established for operating as the service unit.

One or more examples of implementations are set forth in more detail in the accompanying drawings and the description below. Other features will be apparent from the description and drawings, and from the claims.

### BRIEF DESCRIPTION OF DRAWINGS

In the following the invention will be described in greater detail by means of preferred embodiments with reference to the accompanying drawings, in which

FIG. 1 illustrates an example of a communication environment;

FIGS. 2, 3 and 4 illustrate examples apparatuses applying embodiments of the invention;

FIGS. 5A and 5B are flowcharts illustrating embodiments of the invention;

FIGS. 6 and 7 are signalling charts illustrating examples of some embodiments.

### DETAILED DESCRIPTION OF SOME EMBODIMENTS

The following embodiments are only examples. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may also contain also features, structures, units, modules etc. that have not been specifically mentioned.

Embodiments are applicable to any access node, base station, user terminal (UT), user equipment (UE), user device or corresponding component, and/or to any communication system or any combination of different communication systems that support required functionalities.

The protocols used, the specifications of communication systems, servers and user terminals, especially in wireless communication, develop rapidly. Such development may require extra changes to an embodiment. Therefore, all words and expressions should be interpreted broadly and they are intended to illustrate, not to restrict, embodiments.

Many different radio protocols to be used in communications systems exist. Some examples of different communication systems are the universal mobile telecommunications system (UMTS) radio access network (UTRAN or E-UTRAN), long term evolution (LTE®, known also as E-UTRA), long term evolution advanced (LTE-A®), Wireless Local Area Network (WLAN) based on IEEE 802.11 standard, world-wide interoperability for microwave access (WiMAX), Bluetooth®, personal communications services (PCS) and systems using ultra-wideband (UWB) technology. IEEE refers to the Institute of Electrical and Electronics Engineers. LTE and LTE-A are developed by the Third Generation Partnership Project 3GPP.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question has inherent mobility, are a sub-category of cyber-physical systems. Examples of mobile physical systems include mobile robotics and electronics transported by humans or animals.

In the following, different exemplifying embodiments will be described using, as an example of an access architecture to which the embodiments may be applied, a radio access architecture based on long term evolution advanced (LTE Advanced, LTE-A. The embodiments are not, however, restricted to the system given as an example but a person skilled in the art may apply the solution to other communication systems provided with necessary properties. Another example of a suitable communications system is the 5G concept. It is assumed that network architecture in 5G will be quite similar to that of the LTE-advanced. 5G is likely to use multiple input-multiple output (MIMO) antennas, many more base stations or nodes than the LTE (a so-called small cell concept), including macro sites operating in co-operation with smaller stations and perhaps also employing a variety of radio technologies for better coverage and enhanced data rates. 5G will likely be comprised of more than one radio access technology (RAT), each optimized for certain use cases and/or spectrum. It should be appreciated that future networks will most probably utilise network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations to be carried out, at least partly, in a server, host or node operationally coupled to a remote radio head. It is also possible that node operations will be distributed among a plurality of servers, nodes or hosts. It should also be understood that the distribution of labour between core network operations and base station operations may differ from that of the LTE or even be non-existent. Some other technology advancements probably to be used are Software-Defined Networking (SDN), Big Data, and all-IP, which may change the way networks are being constructed and managed.

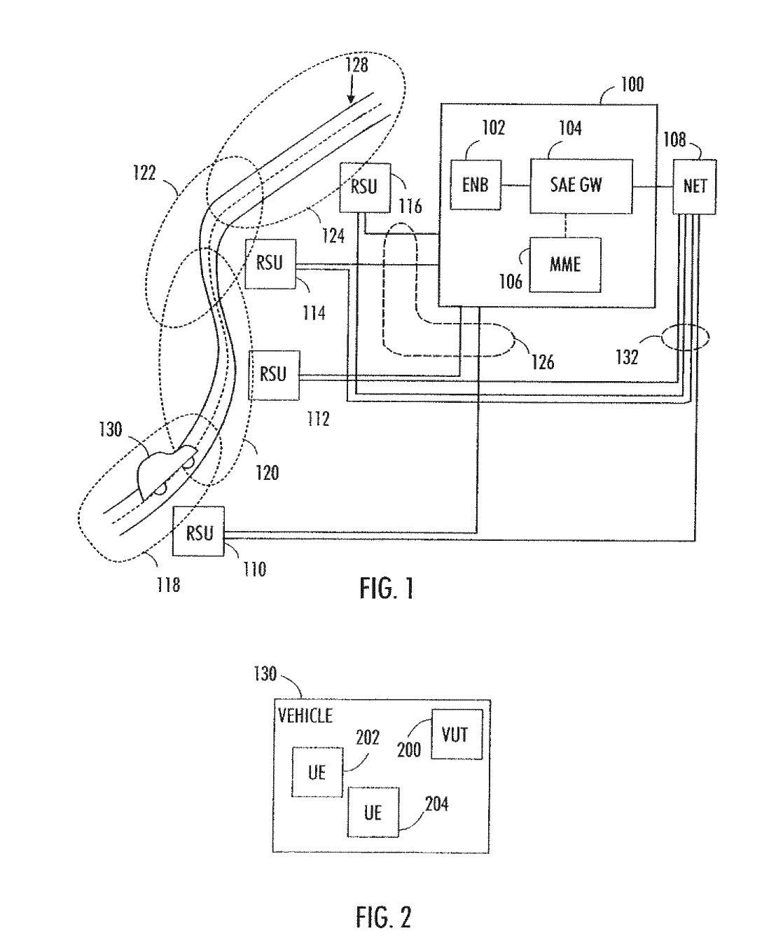

FIG. 1 illustrates a simplified view of an example of a communication environment only showing some elements and functional entities, all being logical units whose implementation may differ from what is shown. The connections shown in FIG. 1 are logical connections; the actual physical connections may be different. It is apparent to a person skilled in the art that the systems also comprise other functions and structures. It should be appreciated that the functions, structures, elements and the protocols used in or for communication are irrelevant to the actual invention. Therefore, they need not to be discussed in more detail here.

In the example of FIG. 1, a cellular radio system based on long term evolution advanced (LTE Advanced, LTE-A) network elements is shown. However, the embodiments described in these examples are not limited to the LTE-A based radio systems but can also be implemented in other radio systems.

FIG. 1 shows an example of a cellular system 100 comprising an eNodeB 102 connected to core network CN 104 of the cellular system.

The eNodeB 102 that may also be called a base station of the cellular system may host the functions for Radio Resource Management: Radio Bearer Control, Radio Admission Control, Connection Mobility Control, Dynamic Resource Allocation (scheduling). Depending on the system, the counterpart on the CN side can be a serving gateway (S-GW, routing and forwarding user data packets), packet data network gateway (P-GW, for providing connectivity of user devices (UEs) to external packet data networks). The cellular system 100 may also comprise a mobile management entity MME 106. The MME is responsible for the overall user terminal control in mobility, session/call and state management with assistance of the eNodeBs through which the user terminals may connect to the network.

The cellular system is also able to communicate with other networks, such as a public switched telephone network or the Internet 108. The communication network may also be able to support the usage of cloud services. It should be appreciated that eNodeBs or their functionalities may be implemented by using any node, host, server or access point etc. entity suitable for such a usage.

In the development of cellular systems fast and reliable vehicle-to-vehicle (V2V) communications has been identified as one of the key areas. Vehicular communications are expected to enable a wide range of applications and services with different characteristics and requirements. Examples of application include safety related applications. The services may relate to delivering traffic information, traffic efficiency, active road safety or notifications of nearby points of interest, for example.

FIG. 1 illustrates an example realisation of a system supporting V2V communications and vehicle-to-Infrastructure (V2I) communications. In the highway scenario example of FIG. 1, the system comprises a set of road side units RSU 110-116 each having a given coverage area 118-124 surrounding the highway 128. On the road there are moving vehicles 130 with multiple integrated communication devices for facilitating V2V/V2I services. In addition, passengers may have devices for normal cellular services. The road side units RSU may be deployed along the road to support V2V/V2I communication. In an embodiment, the RSUs may be considered as an integrated part of a V2V/V2I communication system. The RSUs may be considered as service units facilitating communication of local area services in their coverage area. In an example embodiment for V2V/V2I communication, the RSUs may be configured to act as a wireless LAN access point and provide communications with infrastructure such as the cellular system 100. The devices on the moving vehicle may access to the wireless LAN cell provided by RSUs for V2V/V2I communication. The RSUs 110-116 may be connected to the cellular system 100 with either wired or wireless connections 126. Alternatively or in addition the RSUs 110-116 may also comprise a direct wired or wireless connection 132 to the Internet. The connection may be an Internet Protocol connection.

FIG. 2 illustrates an example of a moving vehicle 130. The vehicle may comprise a set of integrated communication equipment 200 utilising V2V/V2I services and a set of user equipment 202, 204 of the passengers.

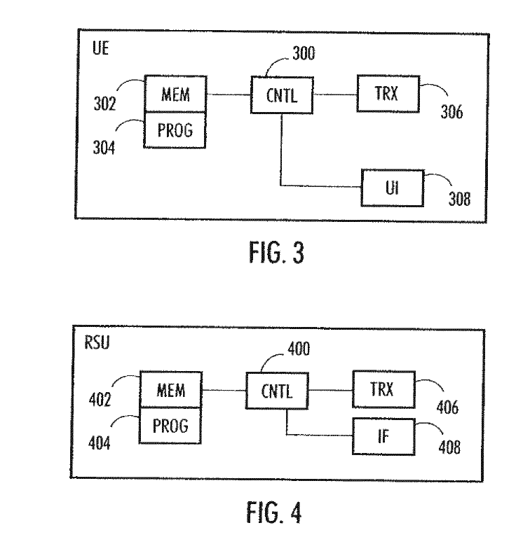

FIG. 3 illustrates a simplified example of an apparatus which may be user equipment 202 or integrated communication equipment 200 or a part of such equipment.

The user device typically refers to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be a nearly exclusive uplink only device, of which an example is a camera or video camera loading images or video clips to a network. A user device may also be a device having capability to operate in Internet of Things (IoT) network which is a scenario in which objects are provided with the ability to transfer data over a network without requiring human-to-human or human-to-computer interaction.

It should be understood that the apparatus is depicted herein as an example illustrating some embodiments. It is apparent to a person skilled in the art that the apparatus may also comprise other functions and/or structures and not all described functions and structures are required. Although the apparatus has been depicted as one entity, different modules and memory may be implemented in one or more physical or logical entities.

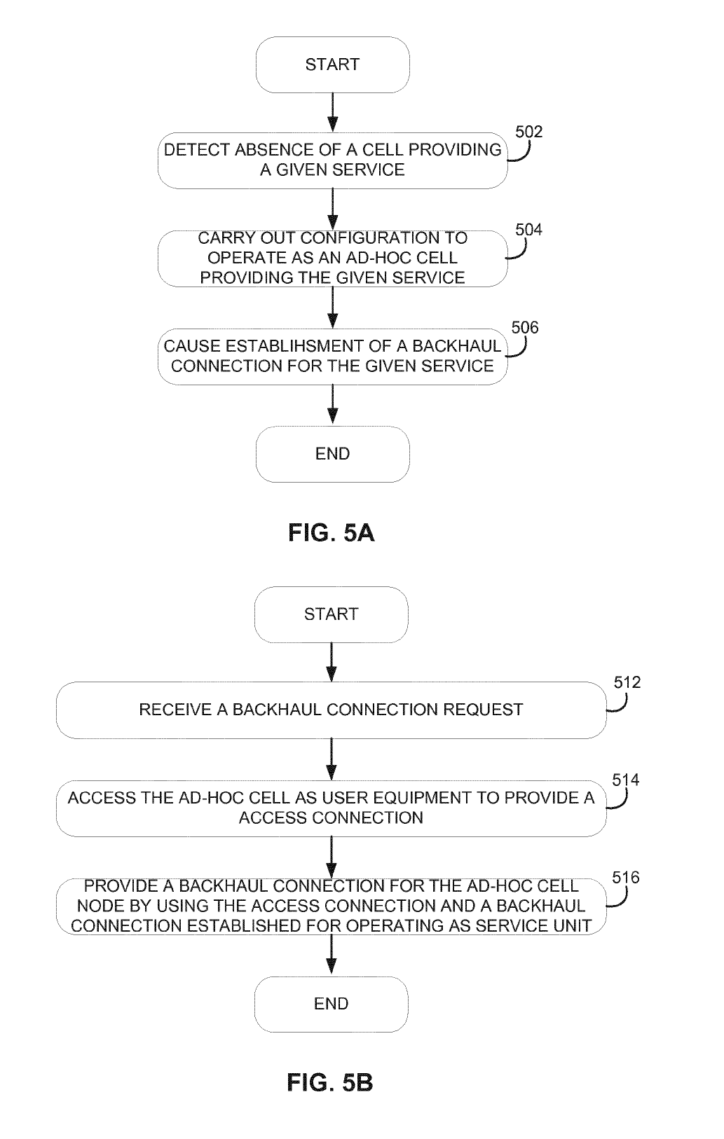

The apparatus of the example includes a control circuitry 300 configured to control at least part of the operation of the apparatus. The control circuitry 300 is configured to execute one or more applications, such as embodiments described below in relation to FIG. 5A.

The apparatus may comprise a memory 302 for storing data or applications. Furthermore the memory may store software 304 executable by the control circuitry 300. The memory may be integrated in the control circuitry. The memory or memory units may be at least partly removable and/or detachably operationally coupled to the apparatus. The memory may be of any type suitable for the current technical environment and it may be implemented using any suitable data storage technology, such as semiconductor-based technology, flash memory, magnetic and/or optical memory devices. It should be appreciated that the memory may be an external or internal memory.

The apparatus comprises at least one transceiver 306. The transceiver is operationally connected to the control circuitry 300. It may be connected to an antenna arrangement 308 comprising one more antenna elements or antennas. The apparatus may comprise a transceiver for cellular communications and a transceiver for wireless local area network communication. The apparatus may also comprise additional transceivers, such as Bluetooth® transceiver, for example.

The software 304 may comprise a computer program comprising program code means adapted to cause the control circuitry 300 of the apparatus to control the transceiver 306.

The apparatus may further comprise user interface 308 operationally connected to the control circuitry 300. The interface may comprise a (touch sensitive) display, a keypad, a microphone, and a speaker, for example. This applies especially to user equipment 202, but also integrated communication equipment 200 may have user interfaces as well.

Another example of an apparatus is an apparatus comprising means (300, 306) for detecting absence of a cell providing a given service, means (300, 306) for carrying out configuration to operate as an ad-hoc cell providing the given service and means (300, 306) for causing establishment of a backhaul connection for the given service.

FIG. 4 illustrates a simplified example of an apparatus which may be road side unit or a part of it.

It should be understood that the apparatus is depicted herein as an example illustrating some embodiments. It is apparent to a person skilled in the art that the apparatus may also comprise other functions and/or structures and not all described functions and structures are required. Although the apparatus has been depicted as one entity, different modules and memory may be implemented in one or more physical or logical entities.

The apparatus of the example includes a control circuitry 400 configured to control at least part of the operation of the apparatus. The control circuitry 400 is configured to execute one or more applications, such as embodiments described below in relation to FIG. 5B.

The apparatus may comprise a memory 402 for storing data or applications. Furthermore the memory may store software 404 executable by the control circuitry 400. The memory may be integrated in the control circuitry. The memory or memory units may be at least partly removable and/or detachably operationally coupled to the apparatus. The memory may be of any type suitable for the current technical environment and it may be implemented using any suitable data storage technology, such as semiconductor-based technology, flash memory, magnetic and/or optical memory devices. It should be appreciated that the memory may be an external or internal memory.

The apparatus may comprise at least one transceiver 406. The transceiver is operationally connected to the control circuitry 400. It may be connected to an antenna arrangement 408 comprising one more antenna elements or antennas. The apparatus may comprise a transceiver for cellular communications and a transceiver for wireless local area network communication, for example.

The apparatus may further comprise interface circuitry 408 configured to connect the apparatus to other devices and network elements of cellular system 100. The interface may provide a wired or wireless connection to the cellular system. The apparatus may be in connection with core network elements, eNodeB's, and with other respective apparatuses of the system 100.

The software 404 may comprise a computer program comprising program code means adapted to cause the control circuitry 400 of the apparatus to control the transceiver 406 and interface circuitry 408.

Another example of an apparatus is an apparatus comprising means (400, 406) for receiving, a backhaul connection request from an ad-hoc cell node, while in a disconnected state regarding a service provided by the ad-hoc cell node, means (400, 406) for accessing the ad-hoc cell as user equipment, and means (400, 406) for providing a backhaul connection for the ad-hoc cell node by using a backhaul connection established for operating as a service unit.

Typically vehicles on roads and on highways are moving with high speeds. Taking the limited coverage of wireless LAN (local area network) cell created by the RSUs (road side units) into consideration, the frequent switch between different RSUs on serving the moving vehicle devices is inevitable. This may complicate the vehicle communication system design and/or impact the system/service performance. Therefore, some kind of moving ad-hoc network with simple implementation from both network and device perspective and less control overhead on mobility management is preferred for vehicle communication system.

On the other hand from spectrum and energy efficiency perspective, the RSUs may be dynamically configured to switch on/off depending on the load of car traffic on the road. However, even in the case of low traffic of cars on the road during e.g. night time, there might be still high communication demand in the area where the few cars are due to e.g. auto-pilot and/or the bandwidth eating entertainment services that the car passengers are using with the user equipment 202, 204. To serve the high demand of the local traffic that are moving together with the cars, the ad-hoc moving cell that is configured among the devices involved in the local services would be a good way to handle the high mobility of few car traffic on the road.

In an embodiment, a service based ad-hoc cell, which uses the same radio access technology as overlay cellular network, may be activated or deactivated on-the-fly. The dynamic configuration including smart triggers for setting up such an ad-hoc cell as well as the method for self-backhauling is proposed taking into account the service need and the operation of the RSUs.

FIG. 5A is a flowchart illustrating an embodiment suitable for configuring and operating a service based ad-hoc cell. The example of FIG. 5A illustrates an example of the operation of user equipment.

In step 502, absence of a cell providing a given service is detected.

For example, user equipment interested to use a certain service (such as V2X service, wherein X may be, amongst others, vehicle (V) or infrastructure (I)) detects that the service unit (such as n RSU) is in off-state, at least regarding this service, or operating in a D2D-mode etc. The detection may be based on absence of a beacon signal or that a service request is not acknowledged etc.

In step 504, on the basis of the detection, configuration to operate as an ad-hoc cell providing the given service is carried out.

Configuration may comprise receiving from a cellular network (from a macro cell or some other overlaying cell which user equipment is able to have a connection to, for example) a command to carry out the configuration, for example based on device capabilities, user profile, status and conditions of traffic load, resource utilization, user mobility (such as speed and/or route), radio environment, location, timelines and so forth. Another example is that the configuration is carried out as a service-based self-configuration, for example according to a similar fashion as in self-organizing network (SON). In the service-based self-configuration, pre-configured policies or rules may be used for activating/deactivating the ad-hoc cell. For instance, when ad-hoc cell setup criteria are met, the device may start searching a service based cell or ad-hoc cell and configure itself to operate as such an ad-hoc cell based on the pre-configuration, if no service based cell is detected.

A service based ad-hoc cell may also provide normal cellular services for devices, if normal cellular services are on-going in parallel with the targeted (given) services. In this way, the devices don't need to maintain dual connections with an overlay cellular network cell for normal cellular services and the ad-hoc cell for targeted services.

In step 506, in connection with the configuration, establishment of a backhaul connection for the given service is caused.

Establishment of a backhaul connection may be carried out by using cellular communications or by requesting a service unit (such as an RSU) to access the ad-hoc cell as user equipment for providing the backhaul connection.

In the case a cellular connection is used, the device providing the backhaul connection may be the one that is operating as the ad-hoc cell. The cellular connection of the involved device for backhauling may be activated on demand, e.g. only when at least one device involved in the ad-hoc cell request cellular services. Another option is that an existing backhaul link in an active state is used.

To facilitate a fast cellular connection establishment for providing a backhaul link over cellular link on demand, an overlay cellular network may maintain the ad-hoc cell context including a radio access network identifier (e.g. C-RNTI) and a relevant radio bearer (RB) configuration on the ad-hoc cell granularity. Additionally, ad-hoc cell wide timing advance information with regard to the cellular network may be maintained in the ad-hoc cell, for instance, a service unit, such as an RSU, may be configured with the timing advance information and provide this information to the ad-hoc cell when the service unit is under the coverage of the ad-hoc cell (it should be understood that the user equipment operating as an ad-hoc cell node may be moving).

As to the option of requesting a service unit (such as an RSU) to access the ad-hoc cell as user equipment for providing the backhaul connection, it may comprise transmitting a backhaul connection request in a paging message, embedded in broadcasted system information or in a device-to-device communications message. When this option is used, the device that operates as the ad-hoc cell node does not need to coordinate the operation of the backhaul link and access link as mobile relay node does and switch between them. A service unit may access to the ad-hoc cell as user equipment and the backhaul (e.g. S1/X2 interface) of the ad-hoc cell may be implemented over an air interface (e.g. RRC and user plane radio bearers).

Additionally, in the latter option, the ad-hoc cell may be operated in two phases/modes: first in a local access phase/mode, wherein all the radio operation related functions are activated in the ad-hoc cell so that the targeted (given) local services, without the need of backhauling, may be offered to connected devices. In this mode, a service unit may access to the ad-hoc cell as UE for providing a backhaul connection, which may trigger the ad-hoc cell change to a full access phase/mode. Second, the ad-hoc cell may be operated in a full access phase/mode. In this mode, the ad-hoc cell can not only provide the targeted local services, but also the normal cellular services, if needed.

To support different ad-hoc cell operation phases/modes, an indication of the operation mode may be provided by the ad-hoc cell. In addition, the operation phase/mode transition may be configured dynamically based on the need of cellular services of the connected user equipment, the availability of the cellular networks and service unit entities, device capabilities, etc.

FIG. 5B is a flowchart illustrating an embodiment suitable for configuring and operating a service based ad-hoc cell. The example of FIG. 5B illustrates an example of the operation of a service unit, such as road side unit (RSU).

In step 512, while in a disconnected state regarding a service provided by the ad-hoc cell node, a backhaul connection request from an ad-hoc cell node is received. The disconnected state may mean an off-state, at least regarding service in question, or that the service unit is operating in a device-to-device (D2D)-mode, etc. the backhaul connection request may be received in a paging message, embedded in broadcasted system information or in a device-to-device communications message. A backhaul connection request may be received in a paging message, embedded in broadcasted system information or in a device-to-device communications message.

In step 514, as a response to the request, accessing the ad-hoc cell as user equipment to provide an access connection. An access connection may be a radio access connection usable for communications. The accessing the ad-hoc cell as user equipment may be carried out in a plurality ways, for example an normal random access procedure or a like may be used, such as transmitting an access request (e.g. RRC Connection Request) to the ad-hoc cell, and receiving an access request response (e.g. RRC Connection Setup) from the ad-hoc cell. The access may also comprise that the service unit when accessing the ad hoc cell indicates a new cause and identity in order to be able to be authenticated and authorized in a service-based fashion, in which case the authentication and authorization may be carried out in a simplified manner, for example by using less complicated ciphering. The service unit may carry out similar procedure for the ad hoc cell. Additionally, when user equipment that operates the ad-hoc cell moves, the service unit may pass user equipment contexts including the ad-hoc cell context to another service unit in order that the other service unit may access the ad-hoc cell as a user equipment and provide a backhaul to the ad-hoc cell, etc.

A backhaul connection (e.g. S1/X2 interface) of the ad-hoc cell is provided by the access connection over an air interface (e.g. RRC and user plane radio bearers) and a backhaul connection established to the service unit for operating as the service unit. The backhaul connection established to the service unit for operating as the service unit can be either a connection to a core network of a cellular network or an Internet Protocol connection to a service server or a local network connection to a service server.

To facilitate a fast cellular connection establishment for providing a backhaul link over cellular link on demand, an overlay cellular network may maintain the ad-hoc cell context including a radio access network identifier (e.g. C-RNTI) and a relevant radio bearer (RB) configuration on the ad-hoc cell granularity. Additionally, ad-hoc cell wide timing advance information with regard to the cellular network may be maintained in the ad-hoc cell, for instance, a service unit, such as an RSU, may be configured with the timing advance information and provide this information to the ad-hoc cell when the service unit is under the coverage of the ad-hoc cell (it should be understood that the user equipment operating as an ad-hoc cell node may be moving).

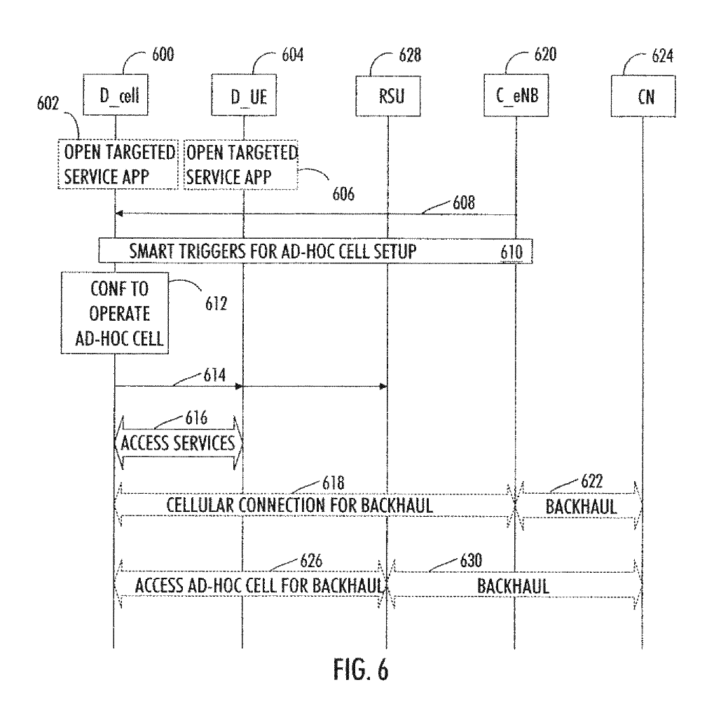

FIG. 6 is a signalling chart illustrating an example of configuring and operating the service based ad-hoc cell.

In this example it is assumed that user equipment denoted as D_cell 600 may be configured to operate a service based ad-hoc cell, which will use the same technology as the overlaying cellular network. The user equipment 600 may be configured to initiate 602 an application requiring a given service. There may be other user equipment (denoted as D_UE 604 in FIG. 6) that are nearby and interested 606 in the same targeted service.

The cell specific parameters of the ad-hoc cell may be configured by the available or further developed Self-Organizing Network (SON)-features of the cellular network. The setup and configuration of the ad-hoc cell may be under the control of the overlaying cellular network, or at least the overlay cellular network may provide 608 the policies and rules and pre-defined basic configuration for self-configured ad-hoc cell establishment. In addition, the overlaying cellular network may also indicate the availability of ad-hoc cells (spectrum/carrier, discovery/reference signal of the ad-hoc cells, for example) for given services to facilitate ad-hoc cell discovery.

Setup of the service based ad-hoc cell may be triggered 610 in a situation where the clear benefits of serving the given services can be achieved from the ad-hoc cell. For example, there may be multiple devices interested in the given services at the same time and moving along the road together. As another example, the RSUs that facilitate the given services may be in off state to save energy and the setup of the ad-hoc cell can serve as many as requested devices on the road moving together.

The user equipment D_cell 600 may be configured to operate 612 as the ad-hoc cell node after the cell has been setup. All the communication (i.e. signalling and data transmission/reception) needed for the given services may be controlled by the ad-hoc cell in a similar way as the overlaying cellular network access. The D_cell may transmit 614 system information such as the supported service and the operation mode of the ad-hoc cell. This means that other user equipment or devices can discover and access to the ad-hoc cell as the normal cellular network cell. The service based access control for the ad-hoc cell may be implemented with different options or any combinations.

In an embodiment, the service based access control may be introduced on spectrum level if dedicated spectrum band is allocated for the targeted service (such as for V2V/V2I services). The devices may be configured from application layer or over cellular network for the specific spectrum on accessing to the given services and followed by the network authentication and authorization.

In an embodiment, the service based access control may be achieved by introducing the service indication in the broadcast signalling (e.g. broadcasted system information of radio access network) of the ad-hoc cell. In this option, the supporting service related information need to be introduced in the broadcast signalling.

In an embodiment, the service based access control may also be achieved by ciphering the cell access information with the given service specific ciphering keys. The devices may be configured from application layer or over cellular network for the ciphering keys to cipher/de-cipher the cell access information.

The other user equipment 602 that are in the coverage of the ad-hoc cell and requires the same service may access 616 the ad-hoc cell.

As mentioned, there are several ways to provide the backhaul link to the ad-hoc cell. In an embodiment, the backhaul link of the ad-hoc cell is provided by the cellular connection 618 of one or more user equipment devices that are involved in the ad-hoc cell, in this example either D_cell 600, D:UE 604 or both. In an embodiment, the cellular connection 618 of the involved device for backhauling may be activated on demand. The eNodeB 620 serving the user equipment connects 622 the backhaul connection to Core Network 624.

In another embodiment, the backhaul link 626 of the ad-hoc cell is provided by the RSU 628, which access to the ad-hoc cell as UE to provide backhaul. The RSU may connect 630 the backhaul connection to the Core Network over IP, for example.

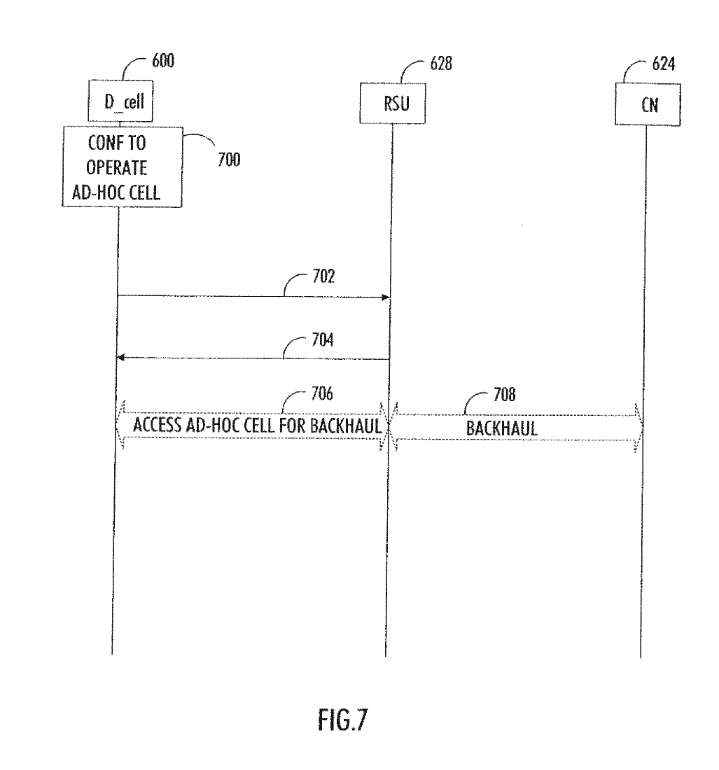

FIG. 7 is a signalling chart illustrating an example of the RSU 628 accessing to the ad-hoc cell to provide backhaul connection. In this example, the user equipment D_cell 600 is configured to operate 700 as the ad-hoc cell node of an ad-hoc cell. The D_cell may transmit 614 system information such as the supported service and operation mode of the ad-hoc cell. All the communication (i.e. signalling and data transmission/reception) needed for the given services may be controlled by the ad-hoc cell in a similar way as the overlaying cellular network access.

The RSU 628 may be configured to detect the ad-hoc cell as normal UE based on broadcasted system information.

The user equipment D_cell 600 may be configured to transmit a request 704 the RSU to create a backhaul connection for the ad-hoc cell as user equipment.

In an embodiment, the request may be implemented in the broadcasted system information. When the RSU 628 detects the system information with the indication that backhaul connection is needed, the RSU may access to the ad-hoc cell as normal UE to provide the backhaul connection over the radio.

In an embodiment, the request may be implemented as paging message to the RSU 628. In this embodiment, all the RSUs may be configured with the same paging occasion and the paging message is targeted to all the RSUs in the coverage of ad-hoc cell.

In an embodiment, the request may be implemented as a device-to-device message between D_cell and the RSU.

As a response to the request, the RSU may be configured to access 706 the ad-hoc cell as user equipment.

The RSU forms a wireless connection 708 to the ad-hoc cell for providing the backhaul connection and connects 710 the backhaul connection to the Core Network over IP, for example. The RSU may be configured to use its own existing backhaul connection to the cellular network.

The steps and related functions described in the above and attached figures are in no absolute chronological order, and some of the steps may be performed simultaneously or in an order differing from the given one. Other functions can also be executed between the steps or within the steps. Some of the steps can also be left out or replaced with a corresponding step.

The apparatuses or controllers able to perform the above-described embodiments may be implemented as an electronic digital computer, or a circuitry which may comprise a working memory (RAM), a central processing unit (CPU), and a system clock. The CPU may comprise a set of registers, an arithmetic logic unit, and a controller. The controller or the circuitry is controlled by a sequence of program instructions transferred to the CPU from the RAM. The controller may contain a number of microinstructions for basic operations. The implementation of microinstructions may vary depending on the CPU design. The electronic digital computer may also have an operating system, which may provide system services to a computer program written with the program instructions.

As used in this application, the term ‘circuitry’ refers to all of the following: (a) hardware-only circuit implementations, such as implementations in only analog and/or digital circuitry, and (b) combinations of circuits and software (and/or firmware), such as (as applicable): (i) a combination of processor(s) or (ii) one or more portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present.

This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

An embodiment provides a computer program embodied on a distribution medium, comprising program instructions which, when loaded into an electronic apparatus, are configured to control the apparatus to execute the embodiments described above.

The computer program may be in source code form, object code form, or in some intermediate form, and it may be stored in some sort of carrier, which may be any entity or device capable of carrying the program. Such carriers include a record medium, computer memory, read-only memory, and a software distribution package, for example. The medium may be a non-transitory medium. Depending on the processing power needed, the computer program may be executed in a single electronic digital computer or it may be distributed amongst a number of computers. Programs, also called program products or computer programs, including software routines, applets and macros, may be stored in any apparatus-readable data storage medium and they include program instructions to perform particular tasks. The data storage medium may be a non-transitory medium. The computer program or computer program product may also be loaded to the apparatus. A computer program product may comprise one or more computer-executable components which, when the program is run, for example by one or more processors possibly also utilizing an internal or external memory, are configured to carry out any of the embodiments or combinations thereof described above. The one or more computer-executable components may be at least one software code or portions thereof. Computer programs may be coded by a programming language or a low-level programming language.

The apparatus may also be implemented as one or more integrated circuits, such as application-specific integrated circuits ASIC. Other hardware embodiments are also feasible, such as a circuit built of separate logic components. A hybrid of these different implementations is also feasible. When selecting the method of implementation, a person skilled in the art will consider the requirements set for the size and power consumption of the apparatus, the necessary processing capacity, production costs, and production volumes, for example.

It will be obvious to a person skilled in the art that, as the technology advances, the inventive concept can be implemented in various ways. The invention and its embodiments are not limited to the examples described above but may vary within the scope of the claims.

1. An apparatus comprising:
at least one processor; and
at least one memory including computer program code,
the at least one memory and the computer program code configured to, with the at least one processor, cause the apparatus at least to:
detect absence of a cell providing a given service;
on the basis of the detection, carry out configuration to operate as an ad-hoc cell providing the given service; and
in connection with the configuration, cause establishment of a backhaul connection for the given service.

2. The apparatus of claim 1, wherein the causing the apparatus to cause the establishment of the backhaul connection is carried out by using cellular communications or by requesting a service unit to access the ad-hoc cell as user equipment for providing the backhaul connection.

3. The apparatus of claim 2, wherein the service unit is an apparatus facilitating communications for local area services.

4. The apparatus of claim 1, wherein the causing the apparatus to carry out configuration comprises receiving from a cellular network a command to carry out the configuration or the configuration is carried out as a service-based self-configuration.

5. The apparatus of claim 1, further comprising causing the apparatus to: in addition to the given service, provide cellular services to user equipment accessing the ad-hoc cell via the cellular network.

6. The apparatus of claim 5, further comprising causing the apparatus to:
obtain ad-hoc cell wide timing advance information with regard to the cellular network for providing the cellular services.

7. The apparatus of any of claim 2, wherein the requesting the service unit to access the ad-hoc cell as user equipment for providing the backhaul connection further comprises transmitting a backhaul connection request in a paging message, embedded in broadcasted system information or in a device-to-device communications message.

8. (canceled)

9. An apparatus comprising:
at least one processor; and
at least one memory including computer program code,
the at least one memory and the computer program code configured to, with the at least one processor, cause the apparatus at least to:
receive, by a service unit, a backhaul connection request from an ad-hoc cell node, while in a disconnected state regarding a service provided by the ad-hoc cell node;
as a response to the request, access the ad-hoc cell as user equipment to provide an access connection; and
provide a backhaul connection for the ad-hoc cell node by using the access connection and a backhaul connection established for operating as the service unit.

10. The apparatus of claim 9, wherein the backhaul connection is provided by using a connection to core network of a cellular network or as an Internet Protocol connection to a service server or local network connection to a service server.

11. The apparatus of claim 9, further comprising causing the apparatus to:
receive the backhaul connection request in a paging message, embedded in broadcasted system information or in a device-to-device communications message.

12. The apparatus of claim 9, further comprising causing the apparatus to:
obtain ad-hoc cell wide timing advance information with regard to the cellular network; and
provide the ad-hoc cell wide timing advance information to the ad-hoc cell.

13. The apparatus of claim 9, wherein causing the apparatus to access the ad-hoc cell as user equipment further comprises causing the apparatus to:
transmit an access request to the ad-hoc cell; and
receive an access request response from the ad-hoc cell.

14. The apparatus of claim 9, wherein causing the apparatus to access the ad-hoc cell as user equipment further comprises causing the apparatus to:
indicate a cause and identity in order to be able to be authenticated and authorized in a service-based fashion.

15. A method, comprising:
detecting absence of a cell providing a given service;
on the basis of the detection, carrying out configuration to operate as an ad-hoc cell providing the given service; and
in connection with the configuration, causing establishment of a backhaul connection for the given service.

16-21. (canceled)

22. A method, comprising:
receiving, by a service unit, a backhaul connection request from an ad-hoc cell node, while in a disconnected state regarding a service provided by the ad-hoc cell node;
as a response to the request, accessing the ad-hoc cell as user equipment to provide an access connection; and
providing a backhaul connection for the ad-hoc cell node by using a backhaul connection established for operating as the service unit.

23-31. (canceled)
